(19) United States
(12) Patent Application Publication
(10) Pub. No.: US 2017/0147941 A1
(43) Pub. Date: May 25, 2017

(54) SUBSPACE PROJECTION OF MULTI-DIMENSIONAL UNSUPERVISED MACHINE LEARNING MODELS

(71) Applicants: Alexander BAUER, Darmstadt (DE); Nico HEIDTKE, Darmstadt (DE)

(72) Inventors: Alexander BAUER, Darmstadt (DE); Nico HEIDTKE, Darmstadt (DE)

(21) Appl. No.: 14/948,608

(22) Filed: Nov. 23, 2015

(51) Int. Cl. G06N 99/00; G06N 7/00

(52) U.S. Cl. CPC G06N 99/005; G06N 7/005

(57) ABSTRACT

A computer-implemented method, apparatus and computer program product for projecting a machine learning model, the method comprising: obtaining a computerized multi-dimensional unsupervised anomaly detection model; obtaining a probability density function of the anomaly detection model; determining samples of the anomaly detection model, based on the probability density function; projecting the samples over at least one dimension set to obtain projected samples; processing the projected samples to obtain decision boundaries of the anomaly detection model over the at least one dimension set; and providing a visual display of the decision boundaries on a display device.

### TECHNICAL FIELD

The presently disclosed subject matter relates to machine learning models and, more particularly, to projecting models to subspaces.

### BACKGROUND

Problems of understanding the behavior or decisions made by machine learning models have been recognized in the conventional art and various techniques have been developed to provide solutions, for example:

Keqian in “On Integrating Information Visualization Techniques into Data Mining: A Review” arXiv preprint arXiv:1503.00202 (2015) state that the exploding growth of digital data in the information era and its immeasurable potential value has called for different types of data-driven techniques to exploit its value for further applications. Information visualization and data mining are two research field with such goal. While the two communities advocate different approaches of problem solving, the vision of combining the sophisticated algorithmic techniques from data mining as well as the intuitivity and interactivity of information visualization is tempting. In this paper, it is attempted to survey recent researches and real world systems integrating the wisdom in two fields towards more effective and efficient data analytics. More specifically, the intersection from a data mining point of view is studied and explored how information visualization can be used to complement and improve different stages of data mining through established theories for optimized visual presentation as well as practical toolsets for rapid development. The survey is organized by identifying three main stages of typical process of data mining, the preliminary analysis of data, the model construction, as well as the model evaluation, and study how each stage can benefit from information visualization.

Thanh-Nghi and Poulet in “Enhancing SVM with visualization” published in Discovery Science. Springer Berlin Heidelberg, 2004 state that understanding the result produced by a data-mining algorithm is as important as the accuracy. Unfortunately, support vector machine (SVM) algorithms provide only the support vectors used as “black box” to efficiently classify the data with a good accuracy. This paper presents a cooperative approach using SVM algorithms and visualization methods to gain insight into a model construction task with SVM algorithms. It is shown how the user can interactively use cooperative tools to support the construction of SVM models and interpret them. A pre-processing step is also used for dealing with large datasets. The experimental results on Delve, Statlog, UCI and bio-medical datasets show that the cooperative tool is comparable to the automatic LibSVM algorithm, but the user has a better understanding of the obtained model.

Cook, Caragea, and Honavar in “Visualization for classification problems, with examples using support vector machines” published in Proceedings of the COMPSTAT 2004 assert that in the simplest form support vector machines (SVM) define a separating hyperplane between classes generated from a subset of cases, called support vectors. The support vectors “mark” the boundary between two classes. The result is an interpretable classifier, where the importance of the variables to the classification, is identified by the coefficients of the variables defining the hyperplane. This paper describes visual methods that can be used with classifiers to understand cluster structure in data. The study leads to suggestions for adaptations to the SVM algorithm and ways for other classifiers to borrow from the SVM approach to improve the result. The end result for any data problem is a classification rule that is easy to understand with similar accuracy.

Rheingans and Desjardins in “Visualizing high-dimensional predictive model quality” published in Proceedings of the conference on Visualization'00. IEEE Computer Society Press, 2000, assert that using inductive learning techniques to construct classification models from large, high-dimensional data sets is a useful way to make predictions in complex domains. However, these models can be difficult for users to understand. The authors developed a set of visualization methods that help users to understand and analyze the behavior of learned models, including techniques for high-dimensional data space projection, display of probabilistic predictions, variable/class correlation, and instance mapping. The results of applying these techniques to models constructed from a benchmark data set of census data are shown, and conclusions are drawn about the utility of these methods for model understanding.

Riveiro and Falkman in “Interactive visualization of normal behavioral models and expert rules for maritime anomaly detection” published in Computer Graphics, Imaging and Visualization, 2009, CGIV'09. Sixth International Conference on IEEE, 2009, state that maritime surveillance systems analyze vast amounts of heterogeneous sensor data from a large number of objects. In order to support the operator while monitoring such systems, the identification of anomalous vessels or situations that might need further investigation may reduce the operator's cognitive load. While it is worth acknowledging that many existing mining applications support identification of anomalous behavior, autonomous anomaly detection systems are rarely used in the real world, since the detection of anomalous behavior is normally not a well-defined problem and therefore, human expert knowledge is needed. This calls for the development of interaction components that can support the user in the detection process. In order to support the comprehension of the knowledge embedded in the system, an interactive way is proposed of visualizing expert rules and normal behavioral models built from the data. The overall goal is to facilitate the validation and update of these models and signatures, supporting the insertion of human expert knowledge while improving confidence and trust in the system.

Eibe and Hall in “Visualizing class probability estimators” published in Springer Berlin Heidelberg, 2003 state that inducing classifiers that make accurate predictions on future data is a driving force for research in inductive learning. However, also of importance to the users is how to gain information from the models produced. Unfortunately, some of the most powerful inductive learning algorithms generate “black boxes”—that is, the representation of the model makes it virtually impossible to gain any insight into what has been learned. The paper presents a technique that can help the user understand why a classifier makes the predictions that it does by providing a two-dimensional visualization of its class probability estimates. It requires the classifier to generate class probabilities but most practical algorithms are able to do so, or can be modified to this end.

Bykov and Wang in “Interaction Visualizations for Supervised Learning” of 2009 present a visualization tool for analyzing machine learning classification algorithms. The key idea behind this tool is to provide the user with per-iteration performance information for the algorithm. This is done through two main views. The first view contains a scatterplot matrix of the data projected into multiple dimension pairs. Each point is labeled with its actual and predicted labels to highlight where in the dataset errors occur at each dimension. The second view provides summary statistics (classification accuracy, number of errors, etc.) at each iteration and an interface to scroll through every iteration of the algorithm. Both of these views are updated in real-time as the algorithm as running As a test of the system, the provided implementation visualizes running a linear SVM algorithm on a breast cancer survival dataset with about 200 points and 3 dimensions.

Kriegel, Kroger, Schubert, and Zimek in “Interpreting and Unifying Outlier Scores” published in Proceedings of the 2011 SIAM International Conference on Data Mining. 2011, 13-24, provide that outlier scores provided by different outlier models differ widely in their meaning, range, and contrast between different outlier models and, hence, are not easily comparable or interpretable. The article proposes a unification of outlier scores provided by various outlier models and a translation of the arbitrary “outlier factors” to values in the range [0, 1] interpretable as values describing the probability of a data object of being an outlier. As an application, it is shown that this unification facilitates enhanced ensembles for outlier detection.

Gao, Jing, and Pang-Ning Tan in “Converting output scores from outlier detection algorithms into probability estimates” published in Data Mining, 2006, ICDM'06 Sixth International Conference on IEEE, 2006 provide that current outlier detection schemes typically output a numeric score representing the degree to which a given observation is an outlier. They argue that converting the scores into well-calibrated probability estimates is more favorable for several reasons. First, the probability estimates allows selecting the appropriate threshold for declaring outliers using a Bayesian risk model. Second, the probability estimates obtained from individual models can be aggregated to build an ensemble outlier detection framework. In this paper, two methods for transforming outlier scores into probabilities are presented. The first approach assumes that the posterior probabilities follow a logistic sigmoid function and learns the parameters of the function from the distribution of outlier scores. The second approach models the score distributions as a mixture of exponential and Gaussian probability functions and calculates the posterior probabilities via the Bayes' rule. The efficacy of both methods is evaluated in the context of threshold selection and ensemble outlier detection.

Goodman, Jonathan, and Jonathan Weare in “Ensemble samplers with affine invariance” published in Communications in Applied Mathematics and Computational Science 5.1 (2010): 65-80 propose a family of Markov chain Monte Carlo methods whose performance is unaffected by affine tranformations of space. The article states that these algorithms are easy to construct and require little or no additional computational overhead, and should be particularly useful for sampling badly scaled distributions. Computational tests show that the affine invariant methods can be significantly faster than standard MCMC methods on highly skewed distributions.

Hempstalk, Kathryn, Eibe Frank, and Ian H. Witten in “One-class classification by combining density and class probability estimation” published in Machine Learning and Knowledge Discovery in Databases, Springer Berlin Heidelberg, 2008. 505-519 assert that one-class classification has important applications such as outlier and novelty detection. It is commonly tackled using density estimation techniques or by adapting a standard classification algorithm to the problem of carving out a decision boundary that describes the location of the target data. In this paper they investigate a simple method for one-class classification that combines the application of a density estimator, used to form a reference distribution, with the induction of a standard model for class probability estimation. In this method, the reference distribution is used to generate artificial data that is employed to form a second, artificial class. In conjunction with the target class, this artificial class is the basis for a standard two-class learning problem. It is explained how the density function of the reference distribution can be combined with the class probability estimates obtained in this way to form an adjusted estimate of the density function of the target class. Using UCI datasets, and data from a typist recognition problem, it is shown that the combined model, consisting of both a density estimator and a class probability estimator, can improve on using either component technique alone when used for one-class classification.

Chandola, Banerjee, and Kumar in “Anomaly detection: A survey” published in ACM Computing Surveys (CSUR) 41.3 (2009): 15 state that anomaly detection is an important problem that has been researched within diverse research areas and application domains. Many anomaly detection techniques have been specifically developed for certain application domains, while others are more generic. This survey tries to provide a structured and comprehensive overview of the research on anomaly detection. They grouped existing techniques into different categories based on the underlying approach adopted by each technique. For each category key assumptions are identified, which are used by the techniques to differentiate between normal and anomalous behavior. When applying a given technique to a particular domain, these assumptions can be used as guidelines to assess the effectiveness of the technique in that domain. For each category, a basic anomaly detection technique is provided, and then it is shown how the different existing techniques in that category are variants of the basic technique. This template provides an easier and succinct understanding of the techniques belonging to each category. Further, for each category, identify the advantages and disadvantages of the techniques in that category are identified. Also provided is a discussion on the computational complexity of the techniques since it is an important issue in real application domains.

The references cited above teach background information that may be applicable to the presently disclosed subject matter. Therefore the full contents of these publications are incorporated by reference herein where appropriate for appropriate teachings of additional or alternative details, features and/or technical background.

### BRIEF SUMMARY

In accordance with certain aspects of the presently disclosed subject matter, there is provided a computer-implemented method for projecting a machine learning model, comprising: obtaining a computerized multi-dimensional unsupervised anomaly detection model; obtaining a probability density function of the anomaly detection model; determining samples of the anomaly detection model, based on the probability density function; projecting the samples over one or dimensions sets to obtain projected samples; processing the projected samples to obtain decision boundaries of the anomaly detection model over the one or more dimension sets; and providing a visual display of the decision boundaries on a display device. The method can further comprise receiving a data point; comparing the data point against the decision boundaries; and providing an indication of a dimension set in which the data point meets an outlier criterion. The method can further comprise providing on the visual display an indication of the data point with the decision boundaries over the dimension set. The method can further comprise determining sampling meta data associated with the machine learning model.

In accordance with further aspects and, optionally, in combination with other aspects of the presently disclosed subject matter, the samples are optionally determined also based on the sampling meta data. In accordance with further aspects and, optionally, in combination with other aspects of the presently disclosed subject matter, the sampling meta data optionally comprises a global location measure of a distribution of the machine learning model. In accordance with further aspects and, optionally, in combination with other aspects of the presently disclosed subject matter, the global location measure optionally comprises one or more items selected from the group consisting of: axis-oriented bounds of the training data set and mean and covariance matrix of the training set. In accordance with further aspects and, optionally, in combination with other aspects of the presently disclosed subject matter, the sampling meta data optionally comprises a subset of the training data set. In accordance with further aspects and, optionally, in combination with other aspects of the presently disclosed subject matter, the subset of the training data set optionally comprises points selected from the training data set, based on one or more techniques selected from the group consisting of: random selection and representative samples. In accordance with further aspects and, optionally, in combination with other aspects of the presently disclosed subject matter, the representative samples are optionally obtained by clustering. In accordance with further aspects and, optionally, in combination with other aspects of the presently disclosed subject matter, the probability density function is optionally a sigmoid function applied to anomaly scores of inputs to the model. In accordance with further aspects and, optionally, in combination with other aspects of the presently disclosed subject matter, the samples of the machine learning model are optionally determined using a Markow-chain Monte Carlo method. In accordance with further aspects and, optionally, in combination with other aspects of the presently disclosed subject matter, starting points for the Markow-chain Monte Carlo method are optionally selected from a training set used for training the model. In accordance with further aspects and, optionally, in combination with other aspects of the presently disclosed subject matter, the visual display optionally comprises a histogram of the samples. The method can further comprise applying graphical characteristics to the histogram. In accordance with further aspects and, optionally, in combination with other aspects of the presently disclosed subject matter, the model optionally comprises a multiplicity of sub-models, optionally each sub model is projected on one dimension, and optionally the visual display comprises a multiplicity of one-dimensional histograms.

In accordance with other aspects of the presently disclosed subject matter, there is provided a computerized system for projecting a machine learning model, the system comprising a processor configured to: obtaining a computerized multi-dimensional unsupervised anomaly detection model; obtaining a probability density function of the anomaly detection model; determining samples of the anomaly detection model, based on the probability density function; projecting the samples over one or more dimension sets to obtain projected samples; processing the projected samples to obtain decision boundaries of the anomaly detection model over the dimension sets; and providing a visual display of the decision boundaries on a display device. The system may be further configured to: receive a data point; comparing the data point against the decision boundaries; and determine a dimension set in which the data point meets an outlier criterion. The system may be further configured to display the data point with the decision boundaries over the dimension set.

In accordance with other aspects of the presently disclosed subject matter, there is provided a computer program product comprising a computer readable storage medium retaining program instructions, which program instructions when read by a processor, cause the processor to perform a method comprising: obtaining a computerized multi-dimensional unsupervised anomaly detection model; obtaining a probability density function of the anomaly detection model; determining samples of the anomaly detection model, based on the probability density function; projecting the samples over one or more dimension sets to obtain projected samples; processing the projected samples to obtain decision boundaries of the anomaly detection model over the dimension sets; and providing a visual display of the decision boundaries on a display device.

### THE BRIEF DESCRIPTION OF THE SEVERAL VIEWS OF THE DRAWINGS

In order to understand the invention and to see how it can be carried out in practice, embodiments will be described, by way of non-limiting examples, with reference to the accompanying drawings, in which:

FIG. 1A illustrates arbitrary 3D data projected onto dimensions 2 and 3 with decision boundaries, for each of four machine learning models, in accordance with some exemplary embodiments of the disclosed subject matter;

FIG. 1B illustrates the data set of FIG. 1A projected onto dimensions 1 and 2 with decision boundaries, for each of the four machine learning models, in accordance with some exemplary embodiments of the disclosed subject matter;

FIG. 1C illustrates the data set of FIG. 1A projected onto dimensions 1 and 3 with decision boundaries, for each of the four machine learning models, in accordance with some exemplary embodiments of the disclosed subject matter;

FIG. 1D illustrates four 1D projections of multi-dimensional traffic monitoring data, in accordance with some exemplary embodiments of the disclosed subject matter;

FIG. 2A illustrates a flowchart of steps in a method for projecting a multidimensional machine learning model, in accordance with some exemplary embodiments of the disclosed subject matter;

FIG. 2B illustrates a flowchart of steps in a method for demonstrating the behavior of a multidimensional machine learning model on a data point, in accordance with some exemplary embodiments of the disclosed subject matter;

FIG. 2C illustrates the 3D data set of FIG. 1A, a specific data point and the decision boundaries, as projected onto dimension pairs, for the K-NN machine learning model, in accordance with some exemplary embodiments of the disclosed subject matter; and

FIG. 3 illustrates a block diagram of a system for projecting a multidimensional machine learning model, in accordance with some exemplary embodiments of the disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating” or the like, refer to the action(s) and/or process(es) of a computer that manipulate and/or transform data into other data, said data represented as physical, such as electronic, quantities and/or said data representing the physical objects.

The term “computer” should be expansively construed to cover any kind of electronic device with data processing capabilities including.

It is to be understood that the term “non-transitory memory” is used herein to exclude transitory, propagating signals, but to include, otherwise, any volatile or non-volatile computer memory technology suitable to the presently disclosed subject matter.

The operations in accordance with the teachings herein may be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

Anomaly detection in machine learning systems is based on learning of a model of normality and detecting deviations of new observations from the learned model. Such models can be built based on various machine learning techniques for example: classification algorithms such as One-Class Support Vector Machines (SVM) or decision trees; clustering methods such as K-Means, nearest neighbor methods such as K-nearest Neighbor (K-NN) or Local outlier factor (LOF); statistical methods such as minimum covariance determinant or Gaussian mixture models, or others. Each of these or other model types has its particular strength and weaknesses regarding computational complexity, memory consumption, accuracy and robustness to noise/anomalies in the training data.

The internal representation of the learned model is generally, and in particular in multi-dimensional or multi-modal models, an abstract set affected by parameters, but the anomaly detection results are not easily predicted or understood in view of the training set, even for experienced data scientists. Rather, only very simple models such as multivariate Gaussian, and estimated parameters such as means or standard deviations can be visualized and easily understood.

Therefore advanced models are usually treated as a black box and data scientists focus on evaluating or understanding the obtained classification performance to determine the quality of the learned model, and the effect of changing parameters on the results.

Thus, one technical problem of machine learning models is the lack of consistent method for obtaining insight, understanding or providing explanation for the performance of a particular model or configuration on a given data set. In the general case, it is hard to impossible to understand how the data set is used for determining normal behavior.

Another technical problem relates to understanding abnormality findings of the model. Some models provide an abnormality score that estimates a deviation of an evaluated data point relatively to the normality model. However, no information is provided about which dimension or dimension combination contributed most to the decision that the point is abnormal. While the abnormality score may be sufficient to determine that a data point is abnormal and to take measures, the consumer or end user of the model is unable to understand which dimensions of the dataset were particularly abnormal, which may be required for identifying the root-cause of the anomaly.

Thus, one technical solution relates to deriving a lower-dimensional visualization of the decision boundary from a high-dimensional unsupervised machine learning model. The visualization may comprise one-dimensional or two-dimensional histograms obtained by projecting the model on one or two dimensions, thus demonstrating the decision boundaries of the model. The term decision boundary relates to a hypersurface, a line in the two dimensional case, that partitions the vector space into sets. In the current context, each decision boundary provides an indication of a normality range to the points within the boundary. Thus, for the same data set, different models may determine different points to be normal or abnormal, and may thus be associated with different boundary lines.

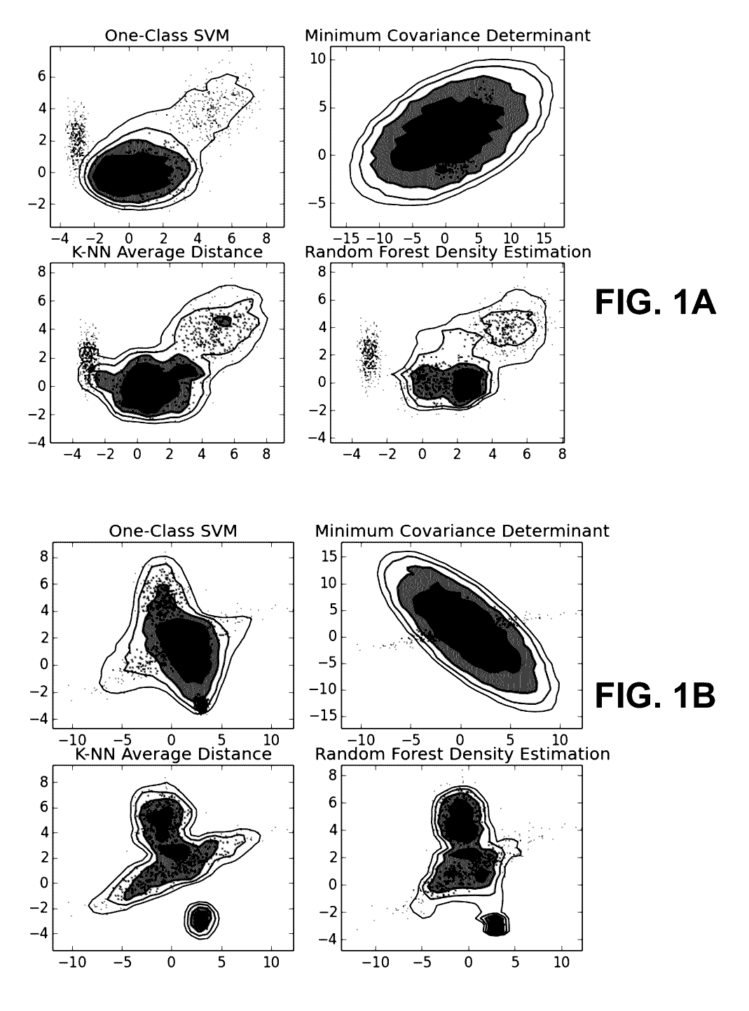

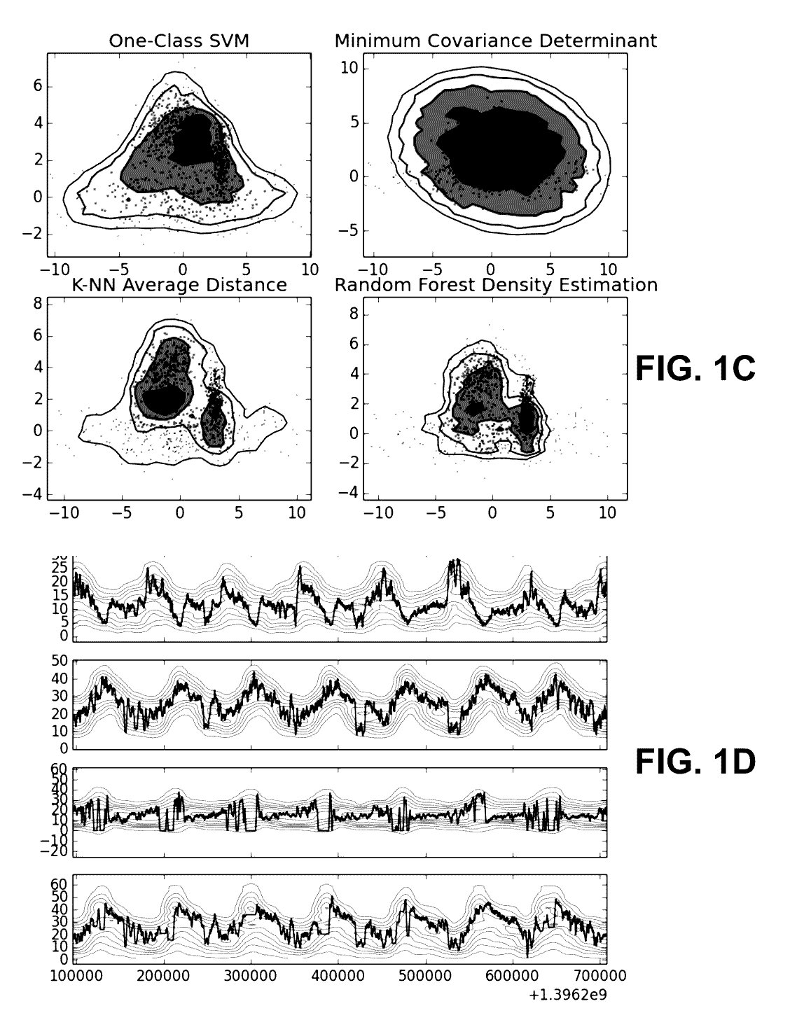

Referring now to FIGS. 1A, 1B and 1C, showing exemplary graphic representations of the output of a method in accordance with the disclosure. FIG. 1A shows two dimensional (2D) projections onto dimensions 2 and 3 of an arbitrary three dimensional (3D) data set with the decision boundaries as processed by four models: one-class SVM, Minimum Covariance Determinant, K-NN Average Distance, and Random Forest Density Estimation; FIG. 1B shows projections onto dimensions 1 and 2 of the same data set with the decision boundaries as processed by the same models, and FIG. 1C shows projections onto dimensions 1 and 3 of the same data set with the decision boundaries as processed by the same models. For each projection of each model, darker areas represent more “normal” cases than lighter areas, such that the lighter the shade, the more “abnormal” a data point located within an area of that shade may be considered, depending for example on an abnormality threshold. It is thus seen that each model determines different decision boundaries for the data set, thus the projections are all different.

Referring now to FIG. 1D showing four one dimensional projections of multi-dimensional traffic monitoring data. Within each projection, the black line shows the data points, while the gray lines mark the decision boundaries. For clarity, the shades are omitted in FIG. 1D, but it will be appreciated that the areas closer to the black line are more “normal” than the areas farther from the black line.

Another technical solution provides for determining, given the decision boundaries of a model and a point determined by the model to be abnormal, one or more one-dimension or two-dimension combinations that demonstrate the abnormality of the data point, for example by showing graphically that the point is in the less-populated areas of the projection, for example the lighter areas. Thus the visualization provides for testing one or more data points against projections of the model onto lower-dimensional subspaces, in order to determine whether each such selected subspace contributes to the classification of the data points as being abnormal.

In the examples of FIGS. 1A, 1B and 1C, it can be seen that each model would yield different decision boundaries and will thus determine different points as abnormal. The graphic representations may assist in understanding which dimensions cause a particular model to determine that a data point is abnormal, for example by providing a visual representation.

One technical effect of the disclosed subject matter relates to providing the ability to graphically examine a model and obtain understanding of its boundaries over different lower dimensions subspaces, regardless of the underlying model type or its parameters.

Another technical effect of the disclosed subject matter relates to receiving an indication to why a particular data point is considered normal or abnormal, which may also be used for improving the model.

Yet another technical effect provides for testing or performing quality assurance for one or more given models, comparing models in order to select the most adequate model for a specific application or environment, predicting the behavior of models over one or more data points, or the like.

Generating histograms that may be used for visual display may require statistical inference, in order to remove unknown variables from a multi-dimensional probability distribution. The statistical inference requires the calculation of an integral over the multi-dimensional probability density function (PDF) associated with the model across all unknown. i.e., uninteresting dimensions. However, calculating the integral in high dimensional space is a computationally expensive process. In order to overcome this difficulty, efficient methods exist for calculating approximations using samples. Methods for generating the set of samples are detailed below.

For those machine learning methods that provide a probability density estimation of the training dataset, such as Multivariate Gaussian, Gaussian Mixture Models, Kernel Density Estimation, or the like. Statistical sampling can be directly applied in order to calculate the approximated integral and thus calculate an estimation of the integral over the multi-dimensional probability density function. However, the output of unsupervised machine learning methods that are not based on statistical theory, such as SVM, K-NN, decision trees or others, is not suitable for this approach.

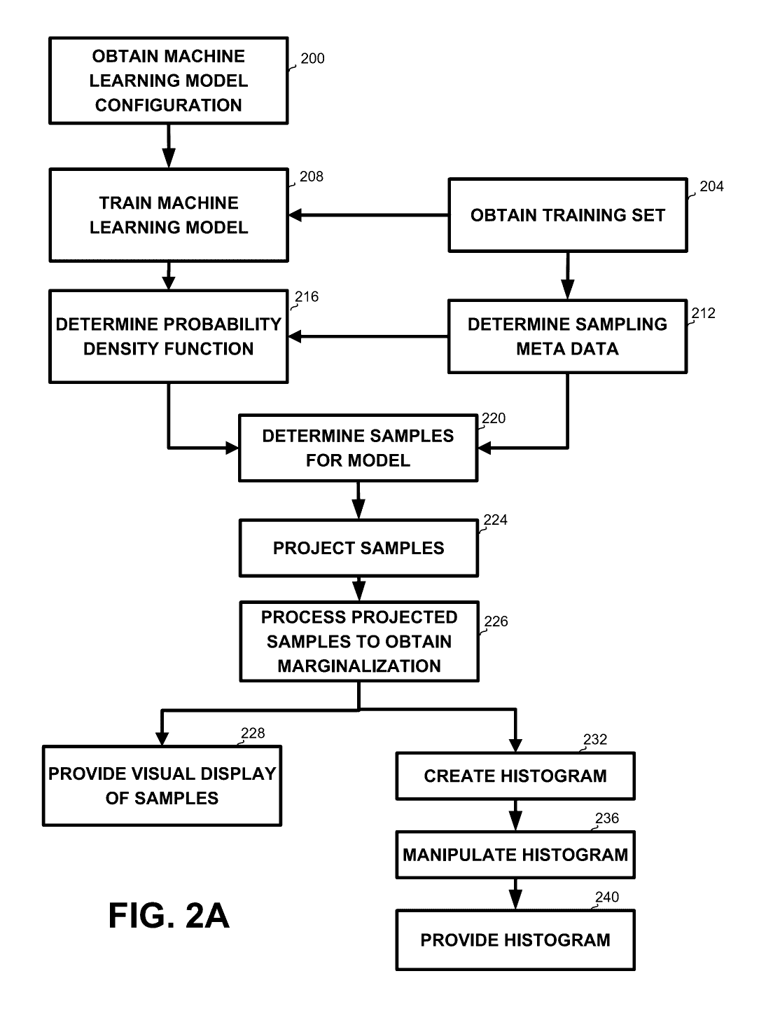

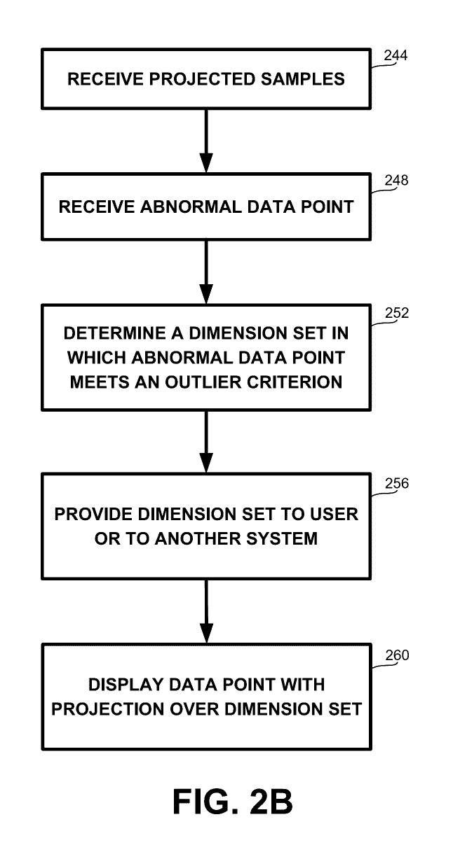

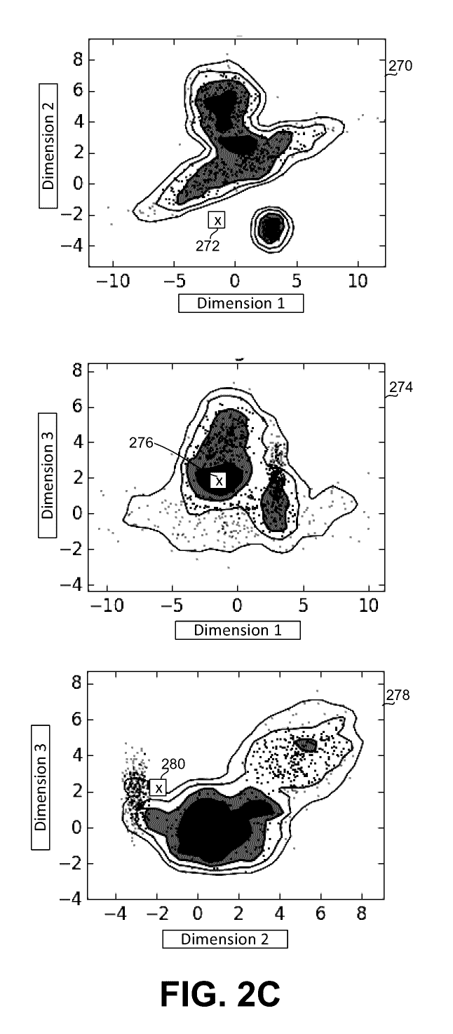

Referring now to FIG. 2A, showing a flowchart of steps in a method for projecting and displaying a multidimensional machine learning model for models including models that are not based on statistical theory.

On step 200, a machine learning configuration may be obtained. The configuration may include the model type, such as One Class Support Vector Machines (OC-SVM), K nearest neighbor (K-NN), or the like; operational parameters such as K for K-NN type; gamma and nu for OC-SVM, support fraction for Multi-scale Continuous and Discontinuous (MCD) algorithm, or the like.

On step 204, a training set may be obtained. In some embodiment the training set may be authentic and received from real-life observations, while in other embodiments the training set may be created artificially.

On step 208, the machine may be trained on the training set, as is known in the art, to obtain the specific model.

On step 212, sampling meta data, i.e., meta data used for sampling, may be obtained. The sampling meta data may depend upon the training set. For example, any one or more meta data items of the following group may be generated: a measure of the global location of the distribution, such as the axis-oriented bounding box of the training set, or the mean and covariance matrix of the training set; a subset of the training data points, selected in accordance with criteria such as random selection, e.g. 0.1% of dataset and at least 100 points, or selecting the most representative samples, e.g. through clustering.

On step 216, a PDF may be determined for the model, by determining a mapping of the machine learning method's decision function to a PDF. In some embodiments, unification of scores produced by unsupervised learning methods for anomaly detection may be used, as detailed for example in Kriegel, Kroger, Schubert and Zimek “Interpreting and Unifying Outlier Scores” published in 2011, or Gao and Pang-Ning “Converting output scores from outlier detection algorithms into probability estimates.” published in 2006. These methods provide for combining multiple machine learning methods into ensembles.

In other embodiments, a sigmoid function may be used for mapping the anomaly score x in range zero to infinity into an unnormalized PDF (UPDF), for a non-limiting example as follows:

$$sigm ( x ) = \frac{1}{1 + {e}^{α * x - β}} ,$$

wherein α and β may be chosen to set the sharpness of the decision boundary, and adjust the implicit threshold on the anomaly score.

For some machine learning methods such as OC-SVM and RFDE, the outlier function mapped by a sigmoid function still has no finite integral. This is due to the fact that the outlier score function of those methods does not grow monotonously with the distance to the center of the distribution. For those models the UPDF may be expressed as a piecewise defined function, with different functions inside and outside the bounding box, which bounding box was calculated as part of the sampling meta-data on step 212 above.

Table 1 below provides suggested implementations for the piecewise sigmoid function inside and outside bounding box for common machine learning methods, as described by Chandola, Banerjee, and Kumar in “Anomaly detection: a Survey” published on 2009.

TABLE 1

| Machine learning method | UPDF, inside bounding box | UPDF, outside bounding box |
|---|---|---|
| One-Class SVM | Sigm (min(1-decision_function,0)) | sigm(1+d_center) |
| K-NN Average distance | Sigm (average_distance) | |
| K-NN Local Outlier Factor | Sigm (local_outlier_factor) | |
| Random Forest Classifier Adjusted | Sigm (outlier_probability) | sigm(1+d_center) |
| Density Estimation | | |

| | |
|---|---|
| Minimum Covariance Determinant | Sigm (mahalanobis_distance) |

Thus, for one class SVM model, within the bounding box, the UPDF is a sigmoid of the minimum between 0 and one minus the decision function, wherein the decision function value is the anomaly score provided by the OCSVM classifier, and outside the bounding box it is a sigmoid of 1 plus the d_center, wherein d_center is the Euclidian distance from the point to be evaluated with the UPDF to the center. The addition of one is required to ensure convergence of the integral.

For K-NN Average distance model, the UPDF is a sigmoid of the average distance to the K nearest neighbors.

For K-NN Local Outlier Factor model, the UPDF is a sigmoid of the local_outlier_factor, which is the outlier score provided by the local outlier factor (LOF) model.

For random forest classifier adjusted density estimation (RFDE) model, within the bounding box, the UPDF is a sigmoid of the outlier probability, i.e. the output of the RFDE model, describing the probability of an outlier score, and outside the bounding box it is a sigmoid of 1 plus the d_center, as detailed in association with the OC-SVM above.

For minimum covariance determinant model, the UPDF is a sigmoid of the mahalanobis_distance. The Mahalanobis distance describes the distance between a data point and the decision boundary of a multi-variate Gaussian model, and is used as the outlier score for this model. All data-points having the same Mahalanobis distance to the center of the distribution share the same probability density.

In order to use statistical sampling for all types of machine learning models, the decision function of the relevant model has to be transformed so that the resulting PDF is acceptable, and in particular: A. that the PDF is non-negative on the whole definition space; and B. that the integral of the PDF is equal to one.

Requirement A may be met by using transformation functions, for example using an exponential function y=exp(x) wherein x is the PDF result. Requirement B can be relaxed by choosing statistical sampling methods that require the definition of the PDF up to a constant factor, for example Markov Chain Monte Carlo methods. These methods create samples through a random walk in the feature space, wherein the walk is guided by the ratio of the PDFs of two data points, and therefore normalization of the PDF is not required. In this case, it is sufficient that the unnormalized PDF (UPDF) has a finite integral, which is ensured through the mapping functions detailed above. For some models such as RFDE and OC-SVM, the finite integral may be ensured by piecewise definition of the mapping function.

Once the UPDF and the sampling meta-data are determined, samples for the model may be determined on step 220. One exemplary method used for approximating the marginalization is Markow-Chain Monte Carlo, for which method the efficiency and quality of the marginalization depends heavily on the starting data points of the Markow chain(s). Good starting points can be derived from the training dataset, to potentially improve the chains convergence. In other embodiments, a sampling method may be used which is invariant to affine transforms, such as the ensemble sampler proposed by Goodman and Weare in “Ensemble samplers with affine invariance” Published in 2010. The sampler may be used with an exemplary non-limiting configuration of 300 chains in parallel to sample from the distribution, initializing the chains with uniformly sampled data points from the bounding box, and discarding the first predetermined number, such as 3 samples in each chain to account for burn-in. In some exemplary non-limiting implementations, about 2000 samples may be determined for one-dimensional projections and about 10000 samples are determined for 2D projections.

On step 224 the created samples may be projected using the model. In some simple embodiments, the coordinates of the non-projected samples may be set to zero. It will be appreciated that no recalculation of samples is required if the selected dimensions are changed, so in some exemplary implementations the samples may be cached when multiple projections need to be created.

Once the samples are available, then on step 226 the samples may be processed for example summed, to obtain the estimated integral, and thus the marginalization of the anomaly detection model over each dimension set over which the samples are projected.

On step 228 a visual display of the samples as projected to one or two dimensions may be provided, for example over a display device, within a file, sent to a user, or the like.

On step 232, a histogram may be created, for example by defining 10-20 equally spaced bins to cover the bounding box as calculated as part of the meta data sampling on step 212.

On step 236, the histogram may be manipulated, for example by coloring, smoothing or otherwise applying graphical characteristics to the histogram. In some embodiments, a bicolored color gradient may be used, and contour lines may be plotted to distinguish between areas of similar outlier probability.

On step 240, the enhanced histogram may be provided to a user as detailed above.

The displays which may be provided on steps 228 or 240 can provide insights to the internal model and its behavior.

Referring now to FIG. 2B, showing a flowchart of steps in a method for demonstrating the behavior of a multidimensional machine learning model on a data point, such that a user may obtain insight to why a datapoint was determined to be abnormal.

On step 244 the projected samples may be received. In some embodiments, the samples may be obtained and projected, while in other embodiments, the projected samples may be received, as projected for example on step 224 above. Alternatively, the histogram determined on steps 232 or 236 may be obtained.

On step 248, a data point may be obtained. The data point may be known to be determined as abnormal by the model.

On step 252, a dimension set, of example of one or two dimensions may be determined, in which the data point meets an outlier criterion, for example it is within a bin of the histogram having probability below a predetermined threshold. It will be appreciated that step 252 may be performed by repeatedly testing the data point against histograms in various dimension sets until one set is found, or until all such sets are found, for example by testing in all one-dimension and two-dimension sets.

On step 256, the one or more dimension sets in which the data point is an outlier may be provided to a user or to another system, for example in the form of text, in a graphic representation showing the histogram of the sample data as projected onto the one-dimension or two-dimension set, with the data point indicated, in a report, or the like.

It will also be appreciated that steps 252 and 256 may also be performed for a data point reported as normal. Such data point may or may not meet any outlier criteria for any one or more one-dimension or two-dimension sets.

On step 260, the data points may be displayed to a user together with a projection of the data set and optionally with the decision boundaries over the dimension sets in which the data point is an outlier.

Referring now to FIG. 2C demonstrating the decision boundaries over the data asset of FIGS. 1A-1C as processed by the K-NN model and projected into two dimensions. In display 270 the model is projected over dimensions 1 and 2, and data point 272 is an outlier; in display 274 the model is projected over dimensions 1 and 3, and data point 276 is on the border of the “normal” areas, and in display 278 the model is projected over dimensions 2 and 3, and data point 276 is well within the “normal” area. Thus, presenting display 270 and optionally display 278 will provide a user with understanding of the dimensions in which the point is abnormal, and thus possible insight into why the point was determined to be abnormal by the model.

It will be appreciated that in some situations no such dimension set may be found, in which case a proper notice may be provided, such that the user may further examine why the data point was reported as abnormal. For example, this may happen due to a criterion incorporating more than two dimensions, a mistake by the model, a problem with a parameter of the problem, or the like.

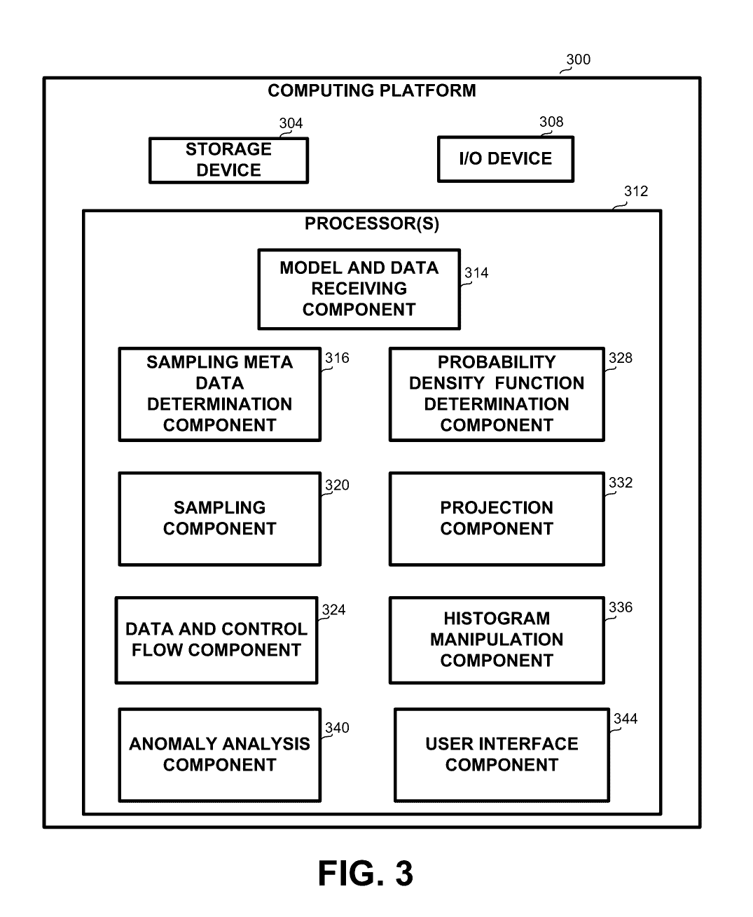

Referring now to FIG. 3, showing a block diagram of a system for projecting a multidimensional machine learning model.

The system may be implemented as a computing platform 300, such as a server, a desktop computer, a laptop computer, a processor, or the like.

In some exemplary embodiments of the disclosed subject matter, computing platform 300 may comprise a storage device 304. Storage device 304 may comprise one or more of the following: a hard disk drive, a Flash disk, a Random Access Memory (RAM), a memory chip, or the like. In some exemplary embodiments, storage device 304 may retain program code operative to cause processor 312 detailed below to perform acts associated with any of the components of computing platform 300.

In some exemplary embodiments of the disclosed subject matter, computing platform 300 may comprise an Input/Output (I/O) device 308 such as a display, a pointing device, a keyboard, a touch screen, or the like. I/O device 308 may be utilized to provide output to or receive input from a user.

Computing platform 300 may comprise a processor 312. Processor 312 may comprise any one or more of the following processing units, such as but not limited to: a Central Processing Unit (CPU), a microprocessor, an electronic circuit, an Integrated Circuit (IC), a Central Processor (CP), or the like. Processor 312 may be utilized to perform computations required by the system or any of its subcomponents. Processor 312 may comprise one or more processing units in direct or indirect communication. Processor 312 may be configured to execute several functional modules in accordance with computer-readable instructions implemented on a non-transitory computer usable medium. Such functional modules are referred to hereinafter as comprised in the processor.

The modules, also referred to as components detailed below, may be implemented as one or more sets of interrelated computer instructions, loaded to and executed by, for example, processor 312 or by another processor. The components may be arranged as one or more executable files, dynamic libraries, static libraries, methods, functions, services, or the like, programmed in any programming language and under any computing environment.

Processor 312 may comprise model and data receiving component 314 for receiving the machine learning model to be examined, or one or more data points, such as the training set.

Processor 312 may comprise sampling meta data determination component 316 for determining sampling meta data. The sampling meta data may be determined as described in association with step 212 of FIG. 2A.

Processor 312 may comprise sampling component 320 for determining the sample points, based upon the sampling meta data and optionally on the model.

Processor 312 may comprise data and control flow component 324 for controlling the activation of the various components, providing the required input and receiving the required output from each component.

Processor 312 may comprise probability density function determination component 328 for determining a probability density function for the model, as described in association with step 216 of FIG. 2A above.

Processor 312 may comprise projection component 332 for projecting one or more data points on a one-dimensional or two-dimensional sets.

Processor 312 may comprise histogram manipulation component 336 for determining a histogram, for example by dividing the training data as projected into bins, and optionally determining graphic or other characteristics, such as colors, contour lines, or the like.

Processor 312 may comprise anomaly analysis component 340 for determining whether a data points is an outlier for one-dimension or two-dimension set. Anomaly analysis component 340 may iterate through all one-dimension or two-dimension set and test whether a data point is an outlier, may select dimension sets in accordance with a criteria, or the like

Processor 312 may comprise user interface component 344 for displaying data to a user, such as histograms or textual data, or to receiving data from a user, such as configuration parameters for the model or for the mapping functions, number of histogram bins, or the like.

It will be appreciated that the methods and system are not limited to one or two dimension sets, and may be equally applicable to larger dimension set, wherein the difference may lie in the enablement or limitations associated with the graphic representation.

It is noted that the teachings of the presently disclosed subject matter are not bound by the described systems. Equivalent and/or modified functionality can be consolidated or divided in another manner and can be implemented in any appropriate combination of software, firmware and hardware and executed on a suitable device.

It is noted that the teachings of the presently disclosed subject matter are not bound by the flowcharts, rather the illustrated operations can occur out of the illustrated order. It is also noted that the flow charts are by no means bound to the systems, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It will also be noted that each block of the block diagrams and/or flowchart illustration may be performed by a multiplicity of interconnected components, or two or more blocks may be performed as a single block or step.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Those skilled in the art will readily appreciate that various modifications and changes can be applied to the embodiments of the invention as hereinbefore described without departing from its scope, defined in and by the appended claims.

What is claimed is:

1. A computer-implemented method for projecting a machine learning model, comprising:
obtaining a computerized multi-dimensional unsupervised anomaly detection model;
determining a probability density function of the anomaly detection model;
determining samples of the anomaly detection model, based on the probability density function;
projecting the samples over at least one dimension set to obtain projected samples;
processing the projected samples to obtain decision boundaries of the anomaly detection model over the at least one dimension set; and
providing a visual display of the decision boundaries on a display device.

2. The method of claim 1, further comprising:
receiving a data point;
comparing the data point against the decision boundaries; and
providing an indication of a dimension set in which the data point meets an outlier criterion.

3. The method of claim 2, further comprising providing on the visual display an indication of the data point with the decision boundaries over the dimension set.

4. The method of claim 1, further comprising determining sampling meta data associated with the machine learning model.

5. The method of claim 4 wherein the samples are determined also based on the sampling meta data.

6. The method of claim 4, wherein the sampling meta data comprises a global location measure of a distribution of the machine learning model.

7. The method of claim 6, wherein the global location measure comprises at least one item selected from the group consisting of: axis-oriented bounds of the training data set and mean and covariance matrix of the training set.

8. The method of claim 6, wherein the sampling meta data comprises a subset of the training data set.

9. The method of claim 8, wherein the subset of the training data set comprises points selected from the training data set, based on at least one technique selected from the group consisting of: random selection and representative samples.

10. The method of claim 9, wherein the representative samples are obtained by clustering.

11. The method of claim 1, wherein the probability density function is determined as a sigmoid function applied to anomaly scores of inputs to the model.

12. The method of claim 1, wherein the samples of the machine learning model are determined using a Markow-chain Monte Carlo method.

13. The method of claim 12, wherein starting points for the Markow-chain Monte Carlo method are selected from a training set used for training the model.

14. The method of claim 1, wherein the visual display comprises a histogram of the samples.

15. The method of claim 14, further comprising applying graphical characteristics to the histogram.

16. The method of claim 1, wherein
the model comprises a multiplicity of sub-models, and wherein
each sub model is projected on one dimension, and wherein
the visual display comprises a multiplicity of one-dimensional histograms.

17. A computerized system for projecting a machine learning model, the system comprising a processor configured to:
obtaining a computerized multi-dimensional unsupervised anomaly detection model;
determining a probability density function of the anomaly detection model;
determining samples of the anomaly detection model, based on the probability density function;
projecting the samples over at least one dimension set to obtain projected samples;
processing the projected samples to obtain decision boundaries of the anomaly detection model over the at least one dimension set; and
providing a visual display of the decision boundaries on a display device.

18. The computerized system of claim 17, wherein the processor is further configured to:
receiving a data point;
comparing the data point against the decision boundaries; and
determining a dimension set in which the data point meets an outlier criterion.

19. The computerized system of claim 18, wherein the processor is further configured to displaying the data point with the decision boundaries over the dimension set.

20. A computer program product comprising a computer readable storage medium retaining program instructions, which program instructions when read by a processor, cause the processor to perform a method comprising:
obtaining a computerized multi-dimensional unsupervised anomaly detection model;
determining a probability density function of the anomaly detection model;
determining samples of the anomaly detection model, based on the probability density function;
projecting the samples over at least one dimension set to obtain projected samples;
processing the projected samples to obtain decision boundaries of the anomaly detection model over the at least one dimension set; and
providing a visual display of the decision boundaries on a display device.
